(19) United States
(12) Patent Application Publication
(10) Pub. No.: US 2007/0286693 A1
(43) Pub. Date: Dec. 13, 2007

(54) Drill bit for PCB

(75) Inventors: Seung Hyun Cho, Seoul (KR); Han Kim, Gyunggi-do (KR); Sun Joong Ryu, Gyunggi-do (KR); Il Soung Yoon, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/727,629

(22) Filed: Mar. 27, 2007

(30) Foreign Application Priority Data
Jun. 12, 2006 (KR) 10-2006-0052599

(51) Int. Cl. B23D 77/00

(52) U.S. Cl. 408/227

(57) ABSTRACT

Disclosed is a drill bit for making a hole through stacked PCBs includes a drill part formed with drilling edges on an outer surface thereof and brought into contact with the PCBs, that is, a workpiece in which to make the hole; a reamer part formed on the rear end of the drill part and having at least one reaming edge for finishing the surface of the hole; and a shank part formed on the rear end of the reamer part and mounted to a machine tool.

### CROSS REFERENCE TO RELATED APPLICATION(S)

This application claims the benefit of Korean Patent Application No. 10-2006-0052599, filed on Jun. 12, 2006, entitled “Drill Bit for PCB”, which is hereby incorporated by reference in its entirety into this application.

### BACKGROUND OF THE INVENTION

1. Field of the Invention

The present invention relates to a drill bit for making a hole through a plurality of stacked printed circuit boards (PCBs) and, more particularly, to a drill bit for a PCB which can make a hole through a workpiece and finish the hole with high precision, thereby improving quality and increasing the yield of products.

2. Description of the Prior Art

Recently, as the degree of integration of a semiconductor device gradually increases, the number of connection pads, which are arranged on the semiconductor device to connect the semiconductor device with outside circuits, increases, and the density of the arranged connection pads also increases. For example, when the minimum processing dimension of a semiconductor device made of silicon, etc. is about 0.2 μm, it is necessary to arrange about 1,000 connection pads on a 10 nm semiconductor device.

Also, in a semiconductor unit, such as a semiconductor package, on which at least one such semiconductor device is mounted, in order to increase the mounting density thereof, the semiconductor package is required to be miniaturized and made slim. In particular, in order to be appropriately applied to a portable information terminal, such as a notebook PC, a PDA (personal digital assistant) or a mobile phone, the miniaturization and slimness of the semiconductor package are regarded as important.

In order to package a semiconductor device, it is necessary to mount the semiconductor device on a substrate and to connect the connection pads of the semiconductor device with the connection pads of the substrate. However, in the case where 1,000 connection pads are arranged on a 10 nm semiconductor device, the arrangement pitch becomes about 40 μm, which is very fine. In order to connect the connection pads arranged at this fine pitch to the connection pads of the substrate, since high precision is required upon forming and connecting wirings on the substrate, the conventional wire bonding or TAB (tape automated bonding) technique cannot be used to provide satisfactory results.

In an effort to cope with this problem, a printed circuit board, which can be structurally and electrically connected to a semiconductor device without requiring the use of a separate connector, has been increasingly used. In particular, among printed circuit boards, in the case of a rigid-flexible printed circuit board, in order to accommodate the trend toward a high degree of integration and a fine pitch for use in portable information terminals such as a notebook PC, a PDA and a mobile phone, it is necessary to define a via hole (hereinafter, simply referred to as a “hole”) with high precision.

The hole (via hole) is formed by a drill machine which has a replaceable type drill bit. Since the drill machine costs 400˜500 thousand dollars, which is expensive, and forms about 10% of the total investment cost of a line, it is the norm for a plurality of PCBs to be stacked and drilled together so as to improve productivity.

FIG. 1 is a perspective view illustrating a conventional drill bit, and FIG. 2 is a diagram illustrating a process for making a hole in stacked PCBs using the conventional drill bit.

Referring to FIGS. 1 and 2, a conventional drill bit 100 is made of alloy and has a predetermined length. The drill bit 100 has a shank 110 which forms a grip and a drill part 120 which integrally extends from the shank 110 and is formed with twisted type drilling edges on the outer surface thereof.

In the drill bit 100, the shank 110 is gripped by the spindle holder (not shown) of a drill machine to receive rotation force for high speed rotation. While the shank 110 rotates at a high speed, the drill part 120 makes a hole through a workpiece. Due to the fact that the shank 110 is mounted to the spindle of the drill machine, the drill bit 100 constructed as mentioned above rotates at a high speed, substantially exceeding 10,000 rpm. The drill part 120 formed on the distal end of the drill bit 100 moves axially and is brought into contact with PCBs 200, that is, the workpiece, thus defining a hole 210 through the PCBs 200.

At this time, the diameter of the drill bit 100 for making the hole 210 through the PCBs 200 is determined in a manner such that it can form a fine hole having a diameter of 0.1˜0.3 mm. Recently, the diameter of the drill bit 100 is determined so as to form a fine hole having a diameter less than 0.1 mm.

The conventional drill bit 100 constructed as mentioned above encounters a problem in that, since the drill bit 100 makes the hole 210 while rotating at a high speed, in the course of making the hole 210, polymer-based debris that is not discharged out of the hole 210 tends to adhere or cause damage to the surface of the drill part 120 due to the increase in local frictional heat. Also, when the drill bit 100 is used for extended periods, as can be readily seen from FIG. 2, the precision with which the hole 210 is made is markedly degraded due to the wear of the drilling edges, thereby resulting in defects in the product and decreasing the yield.

The representative reliability problems caused in the PCBs 200 include delamination and crack formation. The delamination and crack formation mainly occur on the irregular surfaces of the PCBs 200 when the PCBs 200 undergo expansion and contraction due to thermal deformation.

Therefore, due to the construction of the drill bit 100, the roughness of the surface of the hole 210 defined through the PCBs 200 is significantly deteriorated, so that delamination and crack formation occur on the surface of the hole 210, as shown in FIG. 2.

In the case where the PCBs 200, having undergone fine delamination and crack formation which are not detected upon inspection, are distributed as end products, breakdown frequently occurs, and the lifetime of the PCBs 200 is shortened. As a consequence, the user claim cost increases, and the reputation of a manufacturing company can be tarnished.

### SUMMARY OF THE INVENTION

Accordingly, the present invention has been made keeping in mind the above problems occurring in the prior art, and an object of the present invention is to provide a drill bit for a PCB which can make a hole through a plurality of stacked PCBs through a single drilling process and can finish the hole to improve the roughness of the surface of the hole.

In order to achieve the above object, according to one aspect of the present invention, there is provided a drill bit for making a hole through stacked PCBs, comprising a drill part formed with drilling edges on an outer surface thereof and brought into contact with the PCBs as a workpiece to make the hole; a reamer part formed on a rear end of the drill part and having at least one reaming edge for finishing the surface of the hole; and a shank part formed on the rear end of the reamer part and mounted to a machine tool.

According to another aspect of the present invention, the reamer part has a diameter greater than that of the drill part, so that the reamer part can finish the surface of the hole.

According to another aspect of the present invention, 2 to 8 reaming edges are formed to be spaced apart from one another in a circumferential direction and extend straight in the axial direction of the drill bit.

According to still another aspect of the present invention, the reamer part is tapered on the distal end portion thereof so that, when the reamer part is introduced into the hole, the contact area between the reamer part and the surface of the hole is gradually increased.

According to a still further aspect of the present invention, the reamer part has a diameter which is enlarged by 3˜20% when compared to the drill part.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a conventional drill bit;

FIG. 2 is a diagram illustrating a process for making a hole in stacked PCBs using the conventional drill bit;

FIG. 3 is a perspective view illustrating a drill bit in accordance with an embodiment of the present invention;

FIGS. 4 and 5 are cross-sectional views taken along the line A-A of FIG. 3; and

FIG. 6 is a diagram illustrating a process for making a hole in stacked PCBs using the drill bit according to the embodiment of the present invention.

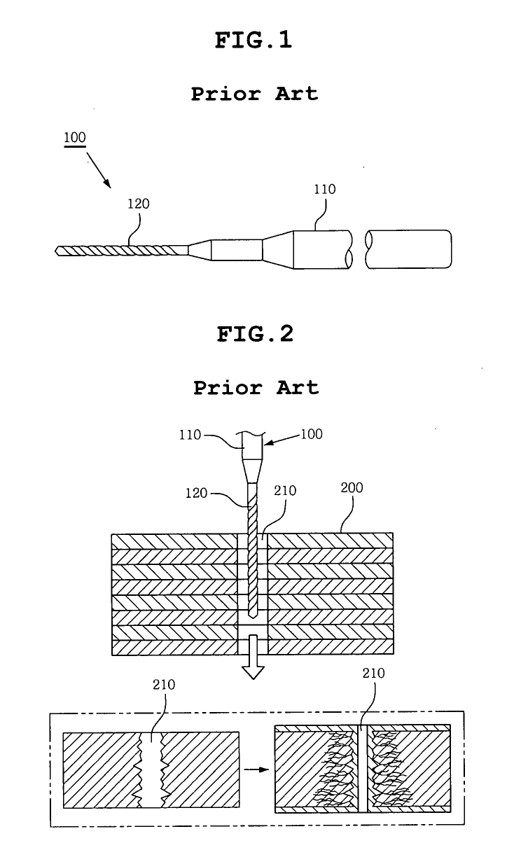

### DETAILED DESCRIPTION OF THE INVENTION

Before describing the embodiment of the present invention, it is to be understood that the terms or words used in this description and the following claims must not be construed to have meanings which are general or can be found in a dictionary. Therefore, considering the notion that an inventor can most properly define the concepts of the terms or words to best explain his or her invention, the terms or words must be understood as having meanings or concepts that conform to the technical spirit of the present invention.

Hereafter, reference will now be made in greater detail to a preferred embodiment of the invention, an example of which is illustrated in the accompanying drawings.

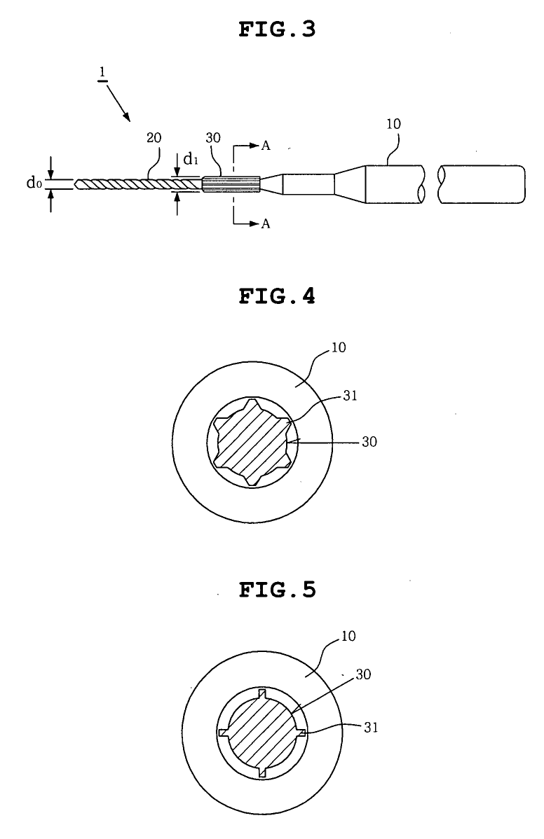

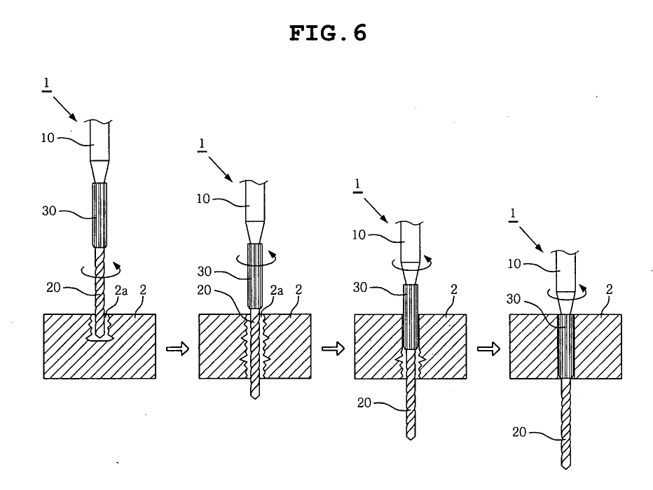

FIG. 3 is a perspective view illustrating a drill bit in accordance with an embodiment of the present invention, FIGS. 4 and 5 are cross-sectional views taken along the line A-A of FIG. 3, and FIG. 6 is a diagram illustrating a process for making a hole in stacked PCBs using the drill bit according to the embodiment of the present invention.

Referring to these drawings, a drill bit 1 in accordance with an embodiment of the present invention is made of an alloy. The drill bit 1 includes a shank part 10, which has the shape of a round bar and a predetermined length, a reamer part 30, which extends from the distal end of the shank part 10 to finish the surface of a hole, and a drill part 20, which extends from the distal end of the reamer part 30 and is formed with helical drilling edges on the outer surface thereof.

In the drill bit 1 having the construction as described above, the shank part 10 and the drill part 20 are structured in the same manner as those of a conventional drill bit for making a hole through a plurality of stacked PCBs.

In the present invention, the reamer part 30 finishes the surface of the hole 2a, which is made by the drill part 20, to improve the roughness thereof, so that the occurrence of the delamination and crack formation resulting from expansion and contraction due to thermal deformation can be minimized.

As can be readily seen from the drawings, the reamer part 30 has 2 to 8 reaming edges 31, which are brought into contact with and finish the surface of the hole 2a. The reaming edges 31 are formed to be spaced apart from one another in the circumferential direction of the drill bit 1 and extend straight in the axial direction of the drill bit 1.

The reamer part 30 configured in this way has a diameter ‘d1’ which is greater than the diameter ‘d0’ of the drill part 20, to finish with high precision the surface of the hole 2a made by the drill part 20. To this end, in the present invention, assuming that the diameter of the hole 2a defined through the PCBs 2 is about 0.1˜0.3 mm, in consideration of the workability of the hole 2a, the diameter of the reamer part 30 is enlarged by 3˜20% in comparison with the drill part 20.

Due to the fact that the reamer part 30 has a diameter greater than that of the drill part 20, when the reamer part 30 is introduced into the hole 2a made by the drill part 20, a shock occurs. In the present invention, in order to prevent this shock, the distal end portion of the reamer part 30 is tapered so that the contact area between the reamer part 30 and the surface of the hole 2a can be gradually increased.

While the taper on the distal end portion of the reamer part 30 can be simply formed through chamfering, it is preferred that the taper be formed to have a gentle inclination angle so as to minimize the shock upon introduction of the reamer part 30 into the hole 2a of the PCBs 2.

The reaming edge 31 can be formed to have a trapezoidal section, as shown in FIG. 4, or a quadrangular section, as shown in FIG. 5. In addition, the reaming edge 31 may have various sections, as long as the workability of the surface of the hole 2a is maintained.

Hereafter, the operation of the drill bit 1 for a PCB according to the present invention, constructed as mentioned above, will be described with reference to FIG. 6.

First, the shank part 10 of the drill bit 1 is mounted to the spindle of a drill machine which can rotate at a high speed greater than 10,000 rpm.

The plurality of stacked PCBs 2 are placed below the distal end portion of the drill bit 1, that is, the drill part 20, and the position on the PCBs 2 at which the hole 2a is to be made is then aligned with the drill part 20 of the drill bit 1.

Thereupon, by actuating the drill machine, as the shank part 10, which is firmly gripped by the spindle of the drill machine, rotates at a high speed, the drill part 20, integrally formed with the shank part 10, also rotates at the high speed and proceeds toward the PCBs 2 to make the hole 2a.

As can be readily seen from the leftmost illustration of FIG. 6, the hole 2a made by the drill part 20 has a rough surface. This is because debris adheres to the surface of the hole 2a or damage occurs to the surface of the hole 2a as the drill part 20 makes the hole 2a while rotating at a high speed, and because the machining precision decreases due to uneven wear resulting from the extended use of the drill bit 1.

The drill part 20 is driven into the PCBs 2 while the hole 2a is made. When the drill part 20 has been driven into the PCBs 2 a predetermined distance, the reamer part 30, which is formed on the rear end of the drill part 20, is introduced into the hole 2a made by the drill part 20.

Accordingly, the reamer part 30, which is introduced into the hole 2a, finishes the surface of the hole 2a using the rearming edges 31 which has a diameter finely greater than that of the hole 2a to decrease the roughness of the surface of the hole 2a. In this way, it is possible to minimize the occurrence of crack formation and delamination in the hole 2a.

As is apparent from the above description, the drill bit for a PCB according to the present invention, constructed and operated as mentioned above, provides advantages in that, since a drill part formed on the distal end of the drill bit makes a hole through stacked PCBs through a single drilling process, and a reamer part formed next to the drill part finishes the hole, the roughness of the surface of the hole can be significantly decreased.

Thus, even when the PCBs repeatedly undergo expansion and contraction due to thermal deformation occurring in the course of manufacture, delamination and crack formation occurring in the hole in the conventional art can be remarkably reduced. As a result, as the defective percentage decreases, the manufacturing cost can be decreased and the yield can be increased. Further, the reliability of an electronic appliance that adopts the PCB manufactured according to the present invention can be remarkably improved. Therefore, the present invention provides industrial benefit.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A drill bit for making a hole through stacked PCBs, comprising:
a drill part formed with drilling edges on an outer surface thereof and brought into contact with the PCBs, which are a workpiece, to make the hole;
a reamer part formed on a rear end of the drill part and having at least one reaming edge for finishing a surface of the hole; and
a shank part formed on a rear end of the reamer part and mounted to a machine tool.

2. The drill bit according to claim 1, wherein the reamer part has a diameter greater than that of the drill part, so that the reamer part can finish the surface of the hole.

3. The drill bit according to claim 1, wherein two to eight reaming edges are formed to be spaced apart from one another in a circumferential direction and extend straight in an axial direction of the drill bit.

4. The drill bit according to claim 2, wherein two to eight reaming edges are formed to be spaced apart from one another in a circumferential direction and extend straight in an axial direction of the drill bit.

5. The drill bit according to claim 1, wherein the reamer part is tapered on a distal end portion thereof so that, when the reamer part is introduced into the hole, a contact area between the reamer part and the surface of the hole is gradually increased.

6. The drill bit according to claim 2, wherein the reamer part is tapered on a distal end portion thereof so that, when the reamer part is introduced into the hole, a contact area between the reamer part and the surface of the hole is gradually increased.

7. The drill bit according to claim 1, wherein the reamer part has a diameter which is enlarged by 3˜20% compared to the drill part.

8. The drill bit according to claim 2, wherein the reamer part has a diameter which is enlarged by 3˜20% compared to the drill part.
